(19) United States
(12) Patent Application Publication
(10) Pub. No.: US 2015/0162611 A1
(43) Pub. Date: Jun. 11, 2015

(54) CATHODE ACTIVE MATERIAL FOR NON-AQUEOUS ELECTROLYTE SECONDARY BATTERY

(71) Applicant: Sharp Kabushiki Kaisha, Osaka-shi, Osaka (JP)

(72) Inventors: Yuichi Kamimura, Osaka-shi (JP); Motoaki Nishijima, Osaka-shi (JP); Tomohisa Yoshie, Osaka-shi (JP); Koji Ohira, Osaka-shi (JP); Toshitsugu Sueki, Osaka-shi (JP)

(21) Appl. No.: 14/412,031

(22) PCT Filed: Jul. 31, 2013
(86) PCT No.: PCT/JP2013/070796

§ 371 Date: Dec. 30, 2014

(30) Foreign Application Priority Data
Jul. 31, 2012 (JP) 2012-169694

(51) Int. Cl. H01M 4/58; H01M 4/48

(52) U.S. Cl. CPC H01M 4/5825; H01M 4/48

(57) ABSTRACT

An object is to provide a cathode active material for a non-aqueous electrolyte secondary battery exhibiting a capacity even at a high rate. The object is achieved by providing a cathode active material for a non-aqueous electrolyte secondary battery including phosphate containing lithium and manganese, in which a manganese site is substituted with at least one element selected from Zr, Sn, Y, and Al, and a phosphorous site is substituted with at least one element selected from Si and Al, and a metal oxide.

### TECHNICAL FIELD

The present invention relates to a cathode active material for a non-aqueous electrolyte secondary battery. More specifically, the present invention relates to a cathode active material that provides a non-aqueous electrolyte secondary battery having excellent cycle characteristics.

### BACKGROUND ART

As a secondary battery for portable electronic devices, a non-aqueous electrolyte secondary battery (particularly, a lithium secondary battery; hereinafter, it will be also referred to just a battery) has been put into practical use and has been widely prevalent. Further, in recent years, a lithium secondary battery has drawn attention not only as a small-sized one for portable electronic devices but also as a large-capacity device for being mounted on a vehicle or for electric power storage. For this reason, there has been an increasing demand for safety, lower manufacturing costs, lifetime and the like.

Generally, a layered transition metal oxide represented by LiCoO₂ is used as an active material for a cathode constituting a non-aqueous electrolyte secondary battery. However, in a full charged state, the layered transition metal oxide is likely to cause oxygen elimination at a comparatively low temperature of around 150° C. Since this oxygen elimination generates heat, oxygen is further eliminated. Therefore, a thermal bursting reaction where oxygen is continuously eliminated can occur. Therefore, in the non-aqueous electrolyte secondary battery having the cathode active material, an accident such as heat generation or fire may happen.

Particularly, for a large sized non-aqueous electrolyte secondary battery having a large capacity for being mounted in a vehicle or for electric power storage, a high level of safety is demanded. Therefore, it has been expected that lithium manganate (LiMn₂O₄) having a spinel structure, lithium iron phosphate (LiFePO₄) having an olivine structure and the like that have a stable structure and do not release oxygen under abnormal conditions are used as a cathode active material.

Further, as a result of the prevalence of a non-aqueous electrolyte secondary battery for being mounted on a vehicle, a great increase in the amount of the cathode active material used is expected. Therefore, exhaustion of resources corresponding to the elements constituting the cathode active material is becoming a problem. It is particularly demanded to reduce the use of cobalt (Co) having a low degree of presence in the earth crust as a resource. For this reason, it has been expected to use lithium nickelate (LiNiO₂) or a solid solution thereof (Li(Co₁₋ₓNix)O₂), lithium manganate (LiMn₂O₄), lithium iron phosphate (LiFePO₄) and the like as a cathode active material.

In view of enhancing the safety and of preventing the exhaustion of resources, LiFePO4 has been widely studied. As a result of the study, LiFePO4 has been practically used as a cathode active material due to improvements in fine pulverization of particles composed of LiFePO4, in substitution of Fe and P with other elements, for coating of the particle surfaces with carbon, and the like.

Here, a problem of LiFePO4 when compared with other cathode active materials is that its average potential is as low as 3.4 V. In view of the average potential, a cathode active material having a high potential olivine type structure such as LiMnPO₄ has been also studied. However, it has been known that since intercalation and deintercalation of Li is difficult in LiMnPO₄ and the conductivity (electron conductivity) of LiMnPO₄ is lower than that of LiFePO₄, the capacity is not likely to be exhibited at a high rate (refer to PTL 1).

In addition, it has been known that at the time of charging, Mn is turned into a trivalent Jahn-Teller ion to cause distortion in the structure of a cathode active material and thus sufficient discharging cannot be achieved (refer to PTL 2).

For this reason, in PTL 2, there is a proposal for substituting a part of Mn with another element for the purpose of increasing the charge/discharge capacity by improving the charge/discharge characteristics. Further, in PTL 2, the concentration of a Mn³⁺ Jahn-Teller ion that is produced at the time of charging is diluted by a cathode active material represented by the formula LiₓMn_{y}A_{1-y}PO₄ (wherein 0≦x≦2; 0<y<1; and A is one kind of metal element selected from Ti, Zn, Mg, and Co, or a plurality of metal elements selected from Ti, Fe, Zn, Mg, and Co) and a structural distortion is suppressed and thus capacity improvement is achieved.

Further, in PTL 3, there is another proposal for a cathode active material represented by the formula LiMn₁₋ₓMₓP_{1-y}si_{y}O₄ (wherein M is at least one element selected from the group consisting of Zr, Sn, Y, and Al; x is within a range of 0<x≦0.5; and y is within a range of 0<y≦0.5).

In PTL 3, a cathode active material in which a volume change due to intercalation and deintercalation of Li is small and has long lifetime can be obtained.

### CITATION LIST

### Patent Literature

PTL 1: Japanese Unexamined Patent Application Publication (Translation of PCT Application) No. 2000-509193

PTL 2: Japanese Unexamined Patent Application Publication No. 2001-307731

PTL 3: International Publication No. 2012/002327

### SUMMARY OF INVENTION

### Technical Problem

Rate characteristics and charge/discharge characteristics are significantly affected not only by the conductivity of LiMnPO₄ itself but also by the conductivity in the vicinity of particles composed of LiMnPO₄. Here, the present inventors have considered that when the conductivity of LiMnPO₄ itself is enhanced and the conductivity in the vicinity of particles composed of LiMnPO₄ is enhanced at the same time, higher capacity can be obtained even at a high rate, and thus have accomplished the present invention.

### Solution to Problem

Thus, according to the present invention, there is provided a cathode active material for a non-aqueous electrolyte secondary battery including phosphate containing lithium and manganese, in which a manganese site is substituted with at least one element selected from Zr, Sn, Y, and Al, and a phosphorous site is substituted with at least one element selected from Si and Al, and a metal oxide.

In addition, according to the present invention, there is provided a cathode including the cathode active material for a non-aqueous electrolyte secondary battery, an electrical conductive material, and a binder.

Further, according to the present invention, there is provided a non-aqueous electrolyte secondary battery including the cathode, an anode, an electrolyte, and a separator.

### Advantageous Effects of Invention

Since the cathode active material according to the present invention includes a metal oxide, it is possible to enhance the conductivity in the vicinity of phosphate and thus obtain a battery having a high capacity even at a high rate.

Further, when the phosphate containing lithium and manganese has a composition represented by the following formula (1)

LiₐMn_{c}M_{d}PₑX_{f}O_{g} (1)

(wherein M is at least one element selected from Zr, Sn, Y and Al; X is at least one element selected from Al and Si; 0≦a≦1.1; 0<c≦1.1; 0<d≦0.5; 0<e≦1.1; 0<f≦0.5; and g is a value determined to satisfy an electroneutral condition), and

the metal oxide has a composition represented by the following formula (2)

M′_{b}O_{z} (2)

(wherein in the formula, M′ is at least one element selected from Zr, Sn, Y, Al, and Si; and (valence of M′)×b=4z),

it is possible to obtain a battery having a higher capacity at a high rate.

When the metal oxide is an oxide of the same metal element as the metal element constituting the phosphate containing lithium and manganese, it is possible to obtain a battery having a higher capacity at a high rate.

### BRIEF DESCRIPTION OF DRAWINGS

FIG. 1 is a diagram showing diffraction patterns and residual curves of cathode active materials of Comparative Example 2 and Example 2.

### DESCRIPTION OF EMBODIMENTS

Hereinafter, the present invention will be described in detail. Incidentally, “A to B” representing a range in the present specification means being larger than or equal to A and smaller than or equal to B. Further, various physical properties mentioned in the present specification stand for the values measured by the methods described in Examples mentioned later unless specifically stated otherwise.

### (I) Cathode Active Material for Non-Aqueous Electrolyte Secondary Battery

A cathode active material for a non-aqueous electrolyte secondary battery (hereinafter, simply referred to as a cathode active material) according to the present invention includes phosphate containing lithium and manganese (hereinafter, simply referred to as phosphate), and a metal oxide. In phosphate, a manganese site is substituted with another metal element and a phosphorous site is substituted with another element, respectively. According to the cathode active material, the present inventors have found that a volume change due to intercalation and deintercalation of Li can be suppressed and long lifetime of the battery can be realized.

### (a) Phosphate Containing Lithium and Manganese

In the phosphate, as another metal element substituting the manganese site, at least one element selected from the group consisting of Zr, Sn, Y, and Al may be used. The manganese site may be substituted with one or more of these metal elements.

As another element substituting the phosphorus site, at least one element selected from the group consisting of Si and Al may be used. The phosphorus site may be substituted with one or more of these metal elements.

Whether Al substitution occurs in the manganese site or the phosphorus site can be measured by a STEM-EELS method. In addition, Al substitution in the manganese site is carried out such that, for example, an empty site is created by reducing the amount of Mn to be charged and Al enters the empty site. On the other hand, Al substitution in the phosphorus site is carried out such that, for example, an empty site is created by reducing the amount of P to be charged and Al enters the empty site.

As the phosphate, for example, phosphate having a composition represented by the following formula (1) can be used.

LiₐMn_{c}M_{d}PₑSi_{f}O_{g} (1)

(wherein M is at least one element selected from Zr, Sn, Y and Al; 0≦a≦1.1; 0<c≦1.1; 0<d≦0.5; 0<e≦1.1; 0<f≦0.5; and g is a value determined to satisfy an electroneutral condition.)

a, c, d, e, f, and g are values quantitatively measured by an ICP mass spectrometry (ICP-MS). a is a value that is changed by charging and discharging. a takes a value of 0, 0.1, 0.2, 0.3, 0.4, 0.5, 0.6, 0.7, 0.8, 0.9, 1.0, or 1.1, c takes a value of 0.1, 0.2, 0.3, 0.4, 0.5, 0.6, 0.7, 0.8, 0.9, 1.0, or 1.1, d takes a value of 0.1, 0.2, 0.3, 0.4, or 0.5, e takes a value of 0.1, 0.2, 0.3, 0.4, 0.5, 0.6, 0.7, 0.8, 0.9, 1.0, or 1.1, and f takes a value of 0.1, 0.2, 0.3, 0.4, or 0.5.

For example, using an ICP-MS 7500cs (manufactured by Agilent Technologies) as a spectrometer, a measurement mode is set as a He mode, an analyzer pressure is set to 5×10⁻⁵ Pa or lower, and Ar and He are used as a use gas. An ICP-MS spectrometry is carried out in a torch and spray chamber for inorganic material by the use of two kinds of reference solutions of XSTC-13B and XSTC-8 according to a calibration curve method as a quantitative measurement method so as to obtain values of a, c, d, e, f, and g.

The phosphate has LiMnPO₄ having an olivine structure as a fundamental structure and Mn and P are partially substituted with other elements whereby a volume change due to intercalation and deintercalation of Li can be suppressed and long lifetime of the battery can be realized.

Generally, in the case of LiMnPO₄ having an olivine type structure, the volume of the crystal structure in the initial stage contracts upon deintercalation of Li by charging. The contraction of volume is resulted by contraction of an a-axis and a b-axis and by expansion of a c-axis of the crystal structure in the initial stage. For this reason, the volume contraction can be suppressed when the contraction ratio of the a- and b-axes is decreased and the expansion ratio of the c-axis is increased by means of substitutions in the constituting elements of LiMnPO₄.

Specifically, when a part of the P site is substituted with another element such as Si and a part of the Mn site is substituted with another metal element together while conducting the electric charge compensation in the crystal structure, the volume change which occurs upon deintercalation of Li can be suppressed and, as a result, the capacity decrease due to repeated charging and discharging can be suppressed.

Incidentally, most of the cathode active materials having the composition of the above formula (1) have an olivine type structure. However, the scope of the present invention also covers a cathode active material having the composition of the above formula (1) but not having an olivine type structure.

In the cathode active material of the present invention, it is preferable that the P site is substituted with Si. Since valences of P and Si are different hereinabove, it is preferable to conduct the electric charge compensation in the crystal structure. For this reason, it is preferable that the Mn site is substituted with M. The electric charge compensation is meant to decrease the sum of the increased electric charges in the crystal structure by substitution of the P site with Si. It is particularly preferable that the sum of the increased electric charges in the crystal structure becomes as close to zero as possible by the electric charge compensation.

Here, in the above formula (1), the valence of P is +5 and that of Si is +4. When, for example, the sum of the electric charges in the crystal structure becomes zero, y which is the substituting amount of Si satisfies the formula of y=x×[(valence of M)−2] in LiₐMn₁₋ₓMₓP_{1-y}X_{y}O₄ which is an example of the formula (1).

Mn may also contain a small amount of Mn where the valence is +3. In this case, the electric charge compensation can be conducted when y as the substituting amount of Si is within a range of x×[(valence of M)−2]−0.05<y<x×[(valence of M)−2]+0.05.

It is also preferable that the changing ratio of the volume of unit lattice in LiₐMn_{c}M_{d}PₑX_{f}O_{g} (for example, Li_{A}Mn₁₋ₓMₓP_{1-y}Si_{y}O₄ (in the formula, A is 0 to x)) after deintercalation of Li to the volume of the unit lattice in the formula (1) is 8% or less. When the volume changing ratio is 8% or less, the capacity retaining ratio at 500 cycles can be set to 80% or more. The lower limit of the changing ratio is 0%.

The element M substituting the Mn site is at least one element selected from the group consisting of Zr, Sn, Y and Al. Accordingly, M may be any one of the four kinds of elements or may be a combination of two or more elements. The element M substituting the Mn site is preferably such an element where the valence is +3 or +4. It is more preferable to substitute the Mn site with an element having a +4 valence particularly because of a large suppressive effect for the volume changing ratio. M may also be a mixture of elements having plural valences. In this case, the valence in stipulating the above y is an average valence.

As to the element M having a +3 valence which can substitute the Mn site, Y or Al which does not change the valence during the synthesis is preferable. When the valence does not change during the synthesis, a cathode active material can be synthesized in a stable manner.

As to the element M having a +4 valence which can substitute the Mn site, Zr or Sn which does not change the valence during the synthesis is preferable. When the valence does not change during the synthesis, a cathode active material can be synthesized in a stable manner.

The substituting amount x in the Mn site is within a range of more than 0 and not more than 0.5. When the range is within the above range, the volume change occurring during intercalation and deintercalation of Li can be suppressed without a significant decrease in discharge capacity when a non-aqueous electrolyte secondary battery is made. For example, x can be 0.01, 0.05, 0.1, 0.15, 0.2, 0.25, 0.3, 0.35, 0.4, 0.45, or 0.5.

It is possible that, the more the substituting amount in the Mn site, the more the suppression of the volume changing ratio. In other words, the more the substituting amount in the Mn site, the more the improvement in the capacity retaining ratio at 500 cycles. When the volume changing ratio is 8% or less, the capacity retaining ratio can be set to 80% or more.

When the Mn site is substituted with an element M having a +3 valence, the amount of Si becomes the same as the substituting amount in the Mn site so as to maintain electric neutrality. In this case, the substituting amount x is preferably 0.05 or more, and more preferably, 0.1 or more.

When the Mn site is substituted with an element M having a +4 valence, the amount of Si becomes two times the substituting amount in the Mn site so as to maintain electric neutrality. In this case, the substituting amount x is preferably 0.05 or more, and more preferably, 0.1 or more.

On the contrary, the more the substituting amount in the Mn site, the less the initial capacity. When it is presumed that a theoretical capacity is different depending upon the substituting element and that only Mn changes its valence number, it is possible to determine the theoretical capacity by the substituting amount.

When Mn is substituted with Zr, the substituting amount x in the Mn site is preferably 0.35 or less in view of achieving the initial capacity of 100 mAh/g or more. Further, in view of achieving the initial capacity of 110 mAh/g or more, the substituting amount x in the Mn site is more preferably 0.3 or less. Furthermore, in view of achieving the initial capacity of 120 mAh/g or more, the substituting amount x in the Mn site is particularly preferably 0.25 or less.

When Mn is substituted with Sn, the substituting amount x in the Mn site is preferably 0.3 or less in view of achieving the initial capacity of 100 mAh/g or more. Further, in view of achieving the initial capacity of 110 mAh/g or more, the substituting amount x in the Mn site is more preferably 0.25 or less. Furthermore, in view of achieving the initial capacity of 120 mAh/g or more, the substituting amount x in the Mn site is particularly preferably 0.2 or less.

When Mn is substituted with Y, the substituting amount x in the Mn site is preferably 0.35 or less in view of achieving the initial capacity of 100 mAh/g or more. Further, in view of achieving the initial capacity of 110 mAh/g or more, the substituting amount x in the Mn site is more preferably 0.3 or less. Furthermore, in view of achieving the initial capacity of 120 mAh/g or more, the substituting amount x in the Mn site is particularly preferably 0.25 or less.

When Mn is substituted with Al, the substituting amount x in the Mn site is preferably 0.45 or less in view of achieving the initial capacity of 100 mAh/g or more. Further, in view of achieving the initial capacity of 110 mAh/g or more, the substituting amount x in the Mn site is more preferably 0.4 or less. Furthermore, in view of achieving the initial capacity of 120 mAh/g or more, the substituting amount x in the Mn site is particularly preferably 0.3 or less.

### (b) Metal Oxide

As a metal element included in the metal oxide, for example, in phosphate, a metal element that can be substituted in the manganese site can be used. Specifically, at least one element selected from the group consisting of Zr, Sn, Y, and Al can be used.

The metal element has a composition represented by the following formula (2).

M′_{b}O_{z} (2)

(wherein in the formula, M′ is at least one element selected from Zr, Sn, Y, Al, and Si; and (valence of M′)×b=4z)

In the formula, when M is one metal element in the formula (1), M′ is preferably the same metal element as M, and when M is two kinds of metal elements, M′ is more preferably a metal element selected from two or more kinds of metal elements. That is, when M in the formula (1) is Zr, M′ in the formula (2) is also more preferably Zr. When a plurality of metal elements, for example, Zr and Sn are used for M in the formula (1), M′ in the formula (2) preferably includes Zr and Sn, only Zr, or only Sn. When the same metal element as M in the formula (1) is included in M′ in the formula (2), a deterioration in the capacity by charging and discharging can be suppressed compared to a case of including other metal elements, and thus it is more preferable.

z is a number that is determined according to the valence of M. Accordingly, for example, when Zr having a +4 valence is used, z is 2 and the metal oxide is ZrO₂. In addition, when Sn having a +4 valence is used, the metal oxide is SnO₂ (z=2), and when Y or Al having a +3 valence is used, the metal oxide is YO_{3/2} (that is, Y₂O₃) or AlO_{3/2} (that is, Al₂O₃) (z=3/2).

The metal oxide may have any crystal structure. For example, in the case of ZrO₂, the crystal structure is a monoclinic crystal structure, a tetragonal crystal structure or the like.

M′ is preferably Zr, Sn, and Si which are tetravalent. Further, Zr and Si having low weight per volume are more preferable. This is because when a large number of metal oxides are present in the vicinity of particles, ion diffusion is disturbed and thus the rate characteristics are deteriorated. ZrO₂ has a weight per volume of 0.046 mol/cm³, SiO₂ has a weight per volume of 0.044 mol/cm³, and SnO₂ has a weight per volume of 0.042 mol/cm³.

The metal oxide M′_{b}O_{z} (wherein M′ is at least one element selected from Zr, Sn, Y, Al, and Si; and (valence of M′)×b=4z) is preferably contained in an amount of 0.03 mol to 0.3 mol with respect to 1 mol of phosphate, and for example, in an amount of 0.03 mol, 0.06 mol, 0.09 mol, 0.12 mol, 0.15 mol, 0.18 mol, 0.22 mol, 0.25 mol, 0.28 mol, and 0.3 mol. When the amount is less than 0.03 mol, a deterioration in the capacity cannot be suppressed in some cases. When the amount is more than 0.3 mol, a deterioration in the capacity is promoted in some cases. The amount of the used metal oxide is more preferably 0.03 mol to 0.2 mol.

The metal oxide and phosphate are preferably present in the cathode active material so as to have a ratio (A/B) between the peak intensities (A) and (B) within a range of 0.03 to 0.3 (wherein the peak intensity (A) means the peak intensity derived from the metal oxide near 30.4 degrees and the peak intensity (B) near 25.5 degrees means the peak intensity derived from the phosphate) in an X-ray diffraction pattern using a Cukα ray. The ratio (A/B) takes a value of, for example, 0.03, 0.06, 0.09, 0.12, 0.15, 0.18, 0.22, 0.25, 0.28, or 0.3. The peak derived from the metal oxide (for example, ZrO₂) near 30.4 degrees represents the presence of a (101) plane in the tetragonal crystal structure or the presence of a (111) plane in the monoclinic crystal structure and the peak derived from the phosphate near 25.5 degrees represents the presence of a (111) plane in the olivine structure. When the ratio A/B is more than 0.3, a deterioration in the capacity is caused. More preferably, the ratio A/B is within a range of 0.05 to 0.2.

Further, the peak derived from the metal oxide near 30.4 degrees preferably has a half value width of 0.6 to 1.2 in view of further improving the cycle characteristics of the cathode active material. The half value width takes a value of 0.6, 0.7, 0.8, 0.9, 1.0, 1.1, or 1.2. The range of the half value width is more preferably 0.7 to 1.1.

The peak near 29° to 32° in the case of SnO₂, the peak near 42° to 44° in the case of Al₂O₃, or the peak near 18° to 20° in the case of SiO₂, is set as (A), and the ratio (A/B) between (A) and (B) are calculated.

### (c) Method for Producing Cathode Active Material

Phosphate can be produced by using, as a starting material, a combination of carbonates, hydroxides, chlorides, sulfates, acetates, oxides, oxalates, nitrates, and the like of the respective elements. Examples of the production method include a firing method, a solid phase method, a sol-gel method, a melting-quenching method, a mechanochemical method, a co-sedimentation method, a hydrothermal method, a spray pyrolysis method or the like. Among these methods, a firing method in an inert atmosphere (for example, a nitrogen atmosphere) (a firing condition is 1 to 48 hours at 400° C. to 800° C.) is simple.

As for the metal oxide, commercially available products can be used or a metal oxide that is obtained in the same method as the method for producing phosphate may be used.

The cathode active material may be obtained by separately producing and then mixing the phosphate and the metal oxide, or may be obtained by producing the phosphate and the metal oxide from a mixture of the starting materials of both the phosphate and the metal oxide at the same time. Since the phosphate and the metal oxide can be more evenly mixed in the latter method, it is advantageous in that the volume changing ratio can be more effectively suppressed and the cycle characteristics can be more effectively improved.

Since a metal M is commonly included in both the phosphate and the metal oxide in the latter method, the cathode active material can be produced at the same time by adding an amount of the starting material of the metal M corresponding to a desired amount of the metal oxide to the starting material of phosphate and producing the phosphate and the metal oxide from the obtained mixture of the starting materials by the above-described method.

### (d) Others

In order to enhance the conductivity, the surface of the cathode active material may be coated with carbon. The coating may extend either to the entire surface of the cathode active material or to a part thereof. Only the phosphate, or only the metal oxide may be coated or both the phosphate and the metal oxide may be coated.

The ratio of carbon to be applied is preferably within a range of 1 part by weight to 10 parts by weight with respect to 100 parts by weight of the cathode active material. When the ratio is less than 1 part by weight, the effect of carbon coating cannot be obtained sufficiently in some cases. When the ratio is more than 10 parts by weight, diffusion of lithium at the interface between the cathode active material and the electrolytic solution is disturbed and thus the capacity of the battery may be decreased. The ratio is more preferable within a range of 1.5 parts by weight to 7 parts by weight.

The method for carbon coating is not particularly limited and a known method can be used. For example, a method for coating the surface by mixing a compound to become a carbon source with the starting material of the phosphate and/or the metal oxide and firing the obtained mixture in an inert atmosphere can be used. For the compound to become a carbon source, it is necessary to use a compound that does not hinder the carbon source from changing to a phosphate and/or metal oxide. Examples of such a compound include sugars such as sucrose, and fructose, glycols such as polyethylene glycol, fats such as lauric acid, pitch, and tar.

### (II) Non-Aqueous Electrolyte Secondary Battery

The non-aqueous electrolyte secondary battery has a cathode, an anode, an electrolyte, and a separator. Hereafter, each constituent material will be described.

### (a) Cathode

A cathode contains the above cathode active material, an electrical conductive material and a binder.

Examples of the cathode include a method where a slurry in which a cathode active material, an electrical conductive material and a binder are mixed with an organic solvent is applied onto an electric collector and a method where a mixed powder comprising a binder, an electrical conductive material and a cathode active material is formed into a sheet and the resulting sheet is press-bonded onto an electric collector.

As a cathode active material, the above cathode active material may be used by being mixed with other cathode active material (such as LiCoO₂, LiMn₂O₄ or LiFePO₄) and MnO₂.

As a binder, polytetrafluoroethylene, polyvinylidene fluoride, polyvinyl chloride, ethylene propylene diene polymer, styrene-butadiene rubber, acrylonitrile-butadiene rubber, fluorine rubber, polyvinyl acetate, polymethyl methacrylate, polyethylene, nitrocellulose, and the like may be used.

As the electrical conductive material, there may be used acetylene black, carbon, graphite, natural graphite, artificial graphite, needle coke, and the like.

As an electric collector, there may be used foamed (porous) metal having continuous pores, metal formed into a honeycomb shape, sintered metal, expanded metal, metal in a nonwoven fabric form, metal sheet, metal foil, perforated metal sheet, metal net, and the like. Examples of the metal include stainless steel and copper.

As an organic solvent, there may be used N-methylpyrrolidone, toluene, cyclohexane, dimethylformamide, dimethylacetamide, methyl ethyl ketone, methyl acetate, methyl acrylate, diethyltriamine, N,N-dimethylaminopropylamine, ethylene oxide, tetrahydrofuran, and the like.

The thickness of the cathode is preferably about 0.01 mm to 20 mm. When the thickness is too thick, the electrical conductivity may lower while, when the thickness is too thin, the capacity per unit area may lower. A cathode prepared by means of applying and drying may be compressed using a roller press or the like for enhancing the packing density of the active material.

### (b) Anode

An anode contains an anode active material, an electric conductive material and a binder.

An anode can be produced by a known method. To be more specific, it can be produced by the same method as mentioned in the method for producing a cathode.

As an anode active material, known one may be used. For constituting a battery of high energy density, it is preferable that the intercalation/deintercalation potential of lithium is near the deposition/dissolution potential of metal lithium. A typical example thereof is a carbon material such as natural or artificial graphite in particles (flakes, rods, fibers, whiskers, spheres, ground particle form, or the like).

Examples of the artificial graphite include a graphite which is prepared by graphitization of mesocarbon microbeads, mesophase pitch powder, isotropic pitch powder or the like. Graphite particles where amorphous carbon adheres onto the surfaces can be used as well. Among them, natural graphite is more preferable because it is less expensive, has a potential near the oxidation reduction potential of lithium and can constitute a battery of high energy density.

It is also possible to use lithium transition metal oxide, lithium transition metal nitride, transition metal oxide, silicon oxide or the like as an anode active material. Among these materials, Li₄Ti₅O₁₂ is more preferable because the flatness of the potential is high and the volume change by charging and discharging is small.

As to an electric conductive material and a binder, any of them exemplified for a cathode may be used.

### (c) Electrolyte

As an electrolyte, there may be used, for example, an organic electrolytic solution, a gel-form electrolyte, a polymer solid electrolyte, an inorganic solid electrolyte and a molten salt.

Examples of an organic solvent constituting the above organic electrolytic solution include cyclic carbonates such as propylene carbonate (PC), ethylene carbonate (EC) or butylene carbonate; chain carbonates such as dimethyl carbonate (DMC), diethyl carbonate (DEC), ethyl methyl carbonate or dipropyl carbonate; lactones such as γ-butyrolactone (GBL) or γ-valerolactone; furans such as tetrahydrofuran or 2-methyltetrahydrofuran; ethers such as diethyl ether, 1,2-dimethoxyethane, 1,2-diethoxyethane, ethoxymethoxyethane or dioxane; dimethyl sulfoxide; sulfolane; methylsulfolane; acetonitrile; methyl formate; and methyl acetate. Each of those organic solvents may be used solely or two or more thereof may be mixed and used.

The cyclic carbonates such as PC, EC or butylene carbonate are high-boiling solvents. Therefore, when the cyclic carbonates are used, it is advantageous to mix with GBL.

Examples of an electrolyte salt constituting the organic electrolytic solution include lithium salts such as lithium borofluoride (LiBF₄), lithium hexafluorophosphate (LiPF₆), lithium trifluoromethanesulfonate (LiCF₃SO₃), lithium trifluoroacetate (LiCF₃COO) or lithium bis(trifluoromethanesulfone)imide (LiN(CF₃SO₂)₂). Only one of those electrolyte salts may be used or two or more thereof may be mixed and used. The salt concentration of the electrolytic solution is suitable to be 0.5 mol/1 to 3 mol/l.

### (d) Separator

A separator is positioned between cathode and anode.

As the separator, examples thereof include porous material and nonwoven fabric. As a material for the separator, a separator which is neither dissolved nor swollen in the organic solvent contained in the electrolyte as mentioned above is preferable. Specific examples thereof include polyester polymers, polyolefin polymers (such as polyethylene or polypropylene), ether polymers and inorganic materials such as glass.

### (e) Others

Besides the cathode, the anode, the electrolyte and the separator, the non-aqueous electrolyte secondary battery can also use other constituent elements which are usually used in a non-aqueous electrolyte secondary battery. Examples of the other constituent elements include a battery container and a safety circuit.

### (f) Method of Producing Non-Aqueous Electrolyte Secondary Battery

A non-aqueous electrolyte secondary battery can be produced, for example, by laminating a cathode and an anode with a separator being interposed therebetween. The thus-prepared laminated product including the cathode, the anode and the separator may, for example, have a planar shape in stripes. Further, in the case of preparing a battery in a tubular or flat shape, the laminated product may be rounded and wound.

One or more laminated product(s) may be inserted into a battery container. Usually, a cathode and an anode are connected to an external electroconductive terminal of the battery. After that, the battery container is usually tightly closed so as to shield the laminated product against the ambient air.

A method for the tight closing is as follows. Thus, in the case of a tubular battery, it is a common method where a lid having a packing made of resin is fit into an opening of a battery container followed by caulking the container. In the case of a square-shaped battery, there may be used a method where a metallic lid called a sealed opening plate is attached to an opening and welding is conducted to tightly close the opening. Besides those methods, a method of sealing with use of a binder and a method of fixing with a bolt through the intermediary of a gasket can be used. Further, a method of sealing with a laminate film in which a thermoplastic resin adheres to a metal foil can be used. Here, an opening for injecting the electrolyte may be provided at the time of sealing. Further, it is also possible to turn on the electricity between cathode and anode before the tight closing so as to remove the generated gas.

The present invention is not limited to the above-mentioned description but various modifications can be made within the scope defined by the claims. Thus, the technical scope of the present invention also covers such an embodiment which is achieved by a combination with a technical means being appropriately modified within a scope of the claims.

### EXAMPLES

The present invention will now be illustrated in more detail by way of Examples although it is not limited to the following Examples. Reagents, and the like used in Examples, analytical grade reagents manufactured by Kishida Chemical Co., Ltd. were used unless specified otherwise.

### Comparative Example 1

### Preparation of Cathode Active Material

As starting source materials, there were used LiCH₃COO as a lithium source, MnCO₃.0.5H₂O as a manganese source, and (NH₄)₂HPO₄ as a phosphorus source. By setting the weight of LiCH₃COO serving as the lithium source to be 0.6599 g, each of the above materials was weighed so that the molar ratio of Li:Mn:P was set to 1:1:1. The materials were well mixed using an agate mortar. The obtained mixture was ground and mixed using a planet-type ball mill. The mixing was carried out under the ball mill condition of a rotation rate of 400 rpm, for a rotation time of 1 hour using zirconia balls of 10 mm diameter and a zirconia pot as a mill pot.

The obtained powder was mixed with a solution obtained by dissolving 15% by weight of sucrose with respect to the obtained powder in an aqueous solution, and the mixture was well mixed using an agate mortar and dried at 60° C. The obtained powder was placed into a quartz pot and was fired in a nitrogen atmosphere at a firing temperature of 550° C. for a firing time of 12 hours at a temperature rising and lowering rate of 200° C./h to obtain a sample composed of LiMnPO₄. It was confirmed that 2.2 parts by weight of carbon with respect to 100 parts by weight of the sample was attached to the surface of the sample.

### <Method of Preparing Battery>

200 g of the cathode active material was weighed and ground in steps of 10 g using an automatic mortar. The ground one was mixed with about 10% by weight of acetylene black (trade name: “Denka Black” manufactured by Denki Kagaku Kogyo) with respect to the cathode active material as an electric conductive material, and about 10% by weight of polyvinylidene fluoride resin powder with respect to the cathode active material as a binder.

This mixture was dissolved in a solvent such as N-methyl-2-pyrrolidone to form a slurry and the obtained slurry was applied onto both surfaces of an aluminum foil having a thickness of 20 μm by a doctor blade method. After the slurry was applied onto one surface, the same slurry was also applied to the rear surface to form coated films on both surfaces of the metal foil. The slurry was applied so that the applied amount per surface was about 15 mg/cm².

After being dried, the coated film was pressed by allowing the film to pass between two metal rolls adjusted to have an interval of about 130 μm so that the thickness including the aluminum foil was about 150 μm. Thus, a cathode was prepared.

The obtained cathode contains a cathode active material, an electrical conductive material, and a binder.

Next, as an anode active material, about 500 g of natural graphite powder having an average particle diameter of about 5 μm was weighed was mixed with about 10% by weight of polyvinylidene fluoride resin powder with respect to the anode active material as a binder.

This mixture was dissolved in a solvent such as N-methyl-2-pyrrolidone to form a slurry and the obtained slurry was applied onto both surfaces of an aluminum foil having a thickness of 12 μm by a doctor blade method. After the slurry was applied onto one surface, the same slurry was also applied to the rear surface to form coated films on both surfaces of the metal foil. The slurry was applied so that the applied amount per surface was about 7 mg/cm².

After being dried, the coated film was pressed by allowing the film to pass between two metal rolls adjusted to have an interval of about 120 μm so that the thickness including the aluminum foil was about 140 μm. Thus, an anode was prepared.

The thus-obtained cathode was cut to prepare ten cathodes having a size of a width of 10 cm and a height of 15 cm. In the same manner, the anode was cut to prepare 11 anodes having a size of a width of 10.6 cm and a height of 15.6 cm. Uncoated parts each having a width of 10 mm and a length of 25 mm on the short sides of the cathode and the anode were prepared as current collecting tabs.

As separators, twenty polypropylene porous films (manufactured by Celgard, LLC.) each having a thickness of 25 μm, a width of 11 cm, and a height of 16 cm were used. A laminated product was obtained by laminating the cathodes, the eleven anodes, and the nine separators in such a manner that the separators are disposed on both surfaces of the cathodes so that the anodes and the cathodes do not have direct contact with each other. The laminated product was fixed with an adhesive tape made of Kapton resin. A cathode collector lead, made of aluminum, which had a width of 10 mm, a length of 30 mm, and a thickness of 100 μm was ultrasonically welded to all the cathode tabs of the fixed laminated product. In the same manner, an anode collector lead, made of nickel, which had a width of 10 mm, a length of 30 mm, and a thickness of 100 μm was ultrasonically welded to all the anode tabs of the fixed laminated product.

The laminated product thus prepared was placed between two aluminum laminate resin films, three of whose sides were heat-sealed. In this state, the laminated product was dehydrated by heating the product for 12 hours at a temperature of about 80° C. in a chamber decompressed by a rotary pump.

The laminated product thus dried was placed in a dry box in an Ar atmosphere, and a flat-plate laminate battery was prepared by injecting about 50 ml of an electrolyte (manufactured by Kishida Chemical Co., Ltd.) and sealing the opening under reduced pressure. The electrolyte used was obtained by dissolving LiPF₆ in a solvent so that the concentration was 1.4 mol/l, and the solvent used was obtained by mixing ethylene carbonate and diethyl carbonate with a volume ratio of 7:3.

### Example 1

### Preparation of Cathode Active Material

As starting source materials, there were used LiCH₃COO as a lithium source, MnCO₃.0.5H₂O as a manganese source, ZrOCl₂.8H₂O as a zirconium source, (NH₄)₂HPO₄ as a phosphorus source, and SiO₂ as a silicon source. By setting the weight of LiCH₃COO serving as the lithium source to be 0.6599 g, each of the above materials was weighed so that the molar ratio of Li:Mn:Zr:P was set to 1:1:0.03:1. The materials were well mixed using an agate mortar. The obtained mixture was ground and mixed using a planet-type ball mill. The mixing was carried out under the ball mill condition of a rotation rate of 400 rpm, for a rotation time of 1 hour using zirconia balls of 10 mm diameter and a zirconia pot as a mill pot.

The obtained powder was mixed with a solution obtained by dissolving 15% by weight of sucrose with respect to the obtained powder in an aqueous solution, and the mixture was well mixed using an agate mortar and dried at 60° C. The obtained powder was placed into a quartz pot and was fired in a nitrogen atmosphere at a firing temperature of 650° C. for a firing time of 12 hours at a temperature rising and lowering rate of 200° C./h to obtain a sample composed of a mixture of LiMnPO₄ and 0.03ZrO₂. It was confirmed that 2.2 parts by weight of carbon with respect to 100 parts by weight of the sample was attached to the surface of the sample.

The powder X-ray diffraction pattern of the obtained sample was measured using a powder X-ray diffraction apparatus MiniFlex II (manufactured by Rigaku Co., Ltd.). When a ratio (A/B) between the peak intensity (A) derived from a metal oxide near 30.4 degrees and the peak intensity (B) derived from phosphate near 25.5 degrees was calculated from the obtained result, the ratio was about 0.12.

Thereafter, a flat-plate laminate battery was prepared by carrying out the same operation as in Comparative Example 1.

### Comparative Example 2

As starting source materials, there were used LiCH₃COO as a lithium source, MnCO₃.0.5H₂O as a manganese source, ZrOCl₂.8H₂O as a zirconium source, (NH₄)₂HPO₄ as a phosphorus source, and SiO₂ as a silicon source. By setting the weight of LiCH₃COO serving as the lithium source to be 0.6599 g, each of the above materials was weighed so that the molar ratio of Li:Mn:Zr:P:Si was set to 1:0.97:0.03:0.94:0.06. The materials were well mixed using an agate mortar. The obtained mixture was ground and mixed using a planet-type ball mill. The mixing was carried out under the ball mill condition of a rotation rate of 400 rpm, for a rotation time of 1 hour using zirconia balls of 1 mm diameter and a zirconia pot as a mill pot.

The obtained powder was mixed with a solution obtained by dissolving 15% by weight of sucrose with respect to the obtained powder in an aqueous solution, and the mixture was well mixed using an agate mortar and dried at 60° C. The obtained powder was placed into a quartz pot and was fired in a nitrogen atmosphere at a firing temperature of 550° C. for a firing time of 12 hours at a temperature rising and lowering rate of 200° C./h to obtain a sample composed of a single layer powder of LiMn_{0.97}Zr_{0.03}P_{0.94}Si_{0.06}O₄. It was confirmed that 2.0 parts by weight of carbon with respect to 100 parts by weight of the sample was attached to the surface of the sample.

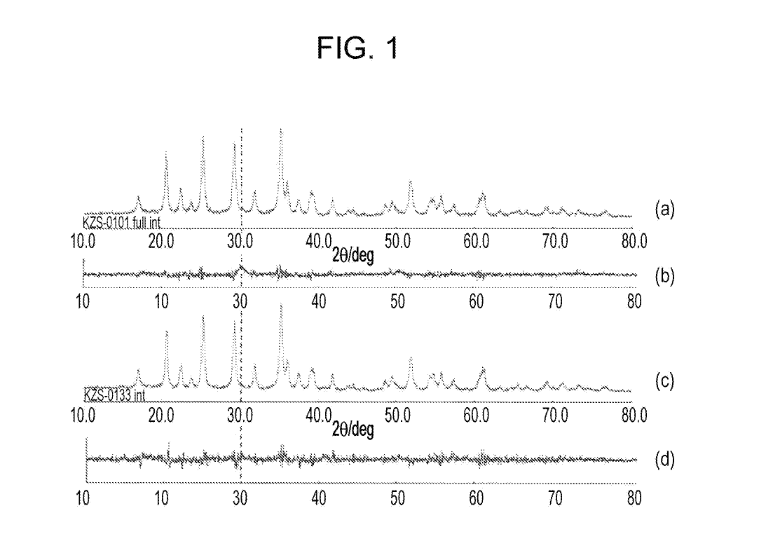

The powder X-ray diffraction pattern of the obtained sample was measured using a powder X-ray diffraction apparatus MiniFlex II (manufactured by Rigaku Co., Ltd.). The obtained result is shown in FIG. 1 (c) and a residual curve excluding a diffraction pattern derived from LiMn_{0.97}Zr_{0.03}P_{0.94}Si_{0.06}O₄ from FIG. 1 (c) is shown in FIG. 1 (d). In FIG. 1 (d), a peak different from the peak derived from LiMn_{0.97}Zr_{0.03}P_{0.94}Si_{0.06}O₄ is not observed.

Thereafter, a flat-plate laminate battery was prepared by carrying out the same operation as in Comparative Example 1.

### Example 2

### Preparation of Cathode Active Material

As starting source materials, there were used LiCH₃COO as a lithium source, MnCO₃.0.5H₂O as a manganese source, ZrOCl₂.8H₂O as a zirconium source, (NH₄)₂HPO₄ as a phosphorus source, and SiO₂ as a silicon source. By setting the weight of LiCH₃COO serving as the lithium source to be 0.6599 g, each of the above materials was weighed so that the molar ratio of Li:Mn:Zr:P:Si was set to 1:0.97:0.06:0.94:0.06. The materials were well mixed using an agate mortar. The obtained mixture was ground and mixed using a planet-type ball mill. The mixing was carried out under the ball mill condition of a rotation rate of 400 rpm, for a rotation time of 1 hour using zirconia balls of 1 mm diameter and a zirconia pot as a mill pot.

The obtained powder was mixed with a solution obtained by dissolving 15% by weight of sucrose with respect to the obtained powder in an aqueous solution, and the mixture was well mixed using an agate mortar and dried at 60° C. The obtained powder was placed into a quartz pot and was fired in a nitrogen atmosphere at a firing temperature of 550° C. for a firing time of 12 hours at a temperature rising and lowering rate of 200° C./h to obtain a sample composed of a mixture of LiMn_{0.97}Zr_{0.03}P_{0.94}Si_{0.06}O₄ and 0.03ZrO₂. It was confirmed that 2.2 parts by weight of carbon with respect to 100 parts by weight of the sample was attached to the surface of the sample.

The powder X-ray diffraction pattern of the obtained sample was measured using a powder X-ray diffraction apparatus MiniFlex II (manufactured by Rigaku Co., Ltd.). The obtained result is shown in FIG. 1 (a) and a residual curve excluding a diffraction pattern derived from LiMn_{0.97}Zr_{0.03}P_{0.94}Si_{0.06}O₄ from FIG. 1 (a) is shown in FIG. 1 (b). In FIG. 1 (b), a peak different from the peak derived from LiMn_{0.97}Zr_{0.03}P_{0.94}Si_{0.06}O₄ is observed near 30.4 degrees. The present inventors consider this peak as a peak derived from ZrO₂. A ratio (A/B) between the peak intensity (A) derived from a metal oxide near 30.4 degrees and the peak intensity (B) derived from phosphate near 25.5 degrees was about 0.11.

Thereafter, a flat-plate laminate battery was prepared by carrying out the same operation as in Comparative Example 1.

### Example 3

### Preparation of Cathode Active Material

As starting source materials, there were used LiCH₃COO as a lithium source, MnCO₃.0.5H₂O as a manganese source, ZrOCl₂.8H₂O as a zirconium source, (NH₄)₂HPO₄ as a phosphorus source, and SiO₂ as a silicon source. By setting the weight of LiCH₃COO serving as the lithium source to be 0.6599 g, each of the above materials was weighed so that the molar ratio of Li:Mn:Zr:P:Si was set to 1:0.9375:0.0925:0.875:0.125. The materials were well mixed using an agate mortar. The obtained mixture was ground and mixed using a planet-type ball mill. The mixing was carried out under the ball mill condition of a rotation rate of 400 rpm, for a rotation time of 1 hour using zirconia balls of 1 mm diameter and a zirconia pot as a mill pot.

The obtained powder was mixed with a solution obtained by dissolving 15% by weight of sucrose with respect to the obtained powder in an aqueous solution, and the mixture was well mixed using an agate mortar and dried at 60° C. The obtained powder was placed into a quartz pot and was fired in a nitrogen atmosphere at a firing temperature of 550° C. for a firing time of 12 hours at a temperature rising and lowering rate of 200° C./h to obtain a sample composed of a mixture of LiMn_{0.9375}Zr_{0.0625}P_{0.875}Si_{0.125}O₄ and 0.03ZrO₂. It was confirmed that 2.2 parts by weight of carbon with respect to 100 parts by weight of the sample was attached to the surface of the sample.

The powder X-ray diffraction pattern of the obtained sample was measured using a powder X-ray diffraction apparatus MiniFlex II (manufactured by Rigaku Co., Ltd.). When a ratio (A/B) between the peak intensity (A) derived from a metal oxide near 30.4 degrees and the peak intensity (B) derived from phosphate near 25.5 degrees was calculated from the obtained result, the ratio was about 0.10.

Thereafter, a flat-plate laminate battery was prepared by carrying out the same operation as in Comparative Example 1.

### Example 4

### Preparation of Cathode Active Material

As starting source materials, there were used LiCH₃COO as a lithium source, MnCO₃.0.5H₂O as a manganese source, ZrOCl₂.8H₂O as a zirconium source, AlCl₃.6H₂O as an aluminum source, (NH₄)₂HPO₄ as a phosphorus source, and SiO₂ as a silicon source. By setting the weight of LiCH₃COO serving as the lithium source to be 0.6599 g, each of the above materials was weighed so that the molar ratio of Li:Mn:Zr:Al:P:Si was set to 1:0.75:0.155:0.125:0.625:0.375. The materials were well mixed using an agate mortar. The obtained mixture was ground and mixed using a planet-type ball mill. The mixing was carried out under the ball mill condition of a rotation rate of 400 rpm, for a rotation time of 1 hour using zirconia balls of 1 mm diameter and a zirconia pot as a mill pot.

The obtained powder was mixed with a solution obtained by dissolving 15% by weight of sucrose with respect to the obtained powder in an aqueous solution, and the mixture was well mixed using an agate mortar and dried at 60° C. The obtained powder was placed into a quartz pot and was fired in a nitrogen atmosphere at a firing temperature of 550° C. for a firing time of 12 hours at a temperature rising and lowering rate of 200° C./h to obtain a sample composed of a mixture of LiMn_{0.75}Zr_{0.125}Al_{0.125}P_{0.625}Si_{0.375}O₄ and 0.03ZrO₂. It was confirmed that 2.2 parts by weight of carbon with respect to 100 parts by weight of the sample was attached to the surface of the sample.

The powder X-ray diffraction pattern of the obtained sample was measured using a powder X-ray diffraction apparatus MiniFlex II (manufactured by Rigaku Co., Ltd.). When a ratio (A/B) between the peak intensity (A) derived from a metal oxide near 30.4 degrees and the peak intensity (B) derived from phosphate near 25.5 degrees was calculated from the obtained result, the ratio was about 0.10.

Thereafter, a flat-plate laminate battery was prepared by carrying out the same operation as in Comparative Example 1.

### Example 5

### Preparation of Cathode Active Material

As starting source materials, there were used LiCH₃COO as a lithium source, MnCO₃.0.5H₂O as a manganese source, ZrOCl₂.8H₂O as a zirconium source, (NH₄)₂HPO₄ as a phosphorus source, and SiO₂ as a silicon source. By setting the weight of LiCH₃COO serving as the lithium source to be 0.6599 g, each of the above materials was weighed so that the molar ratio of Li:Mn:Zr:P:Si was set to 1:0.9375:0.0625:0.875:0.125. The materials were well mixed using an agate mortar. The obtained mixture was ground and mixed using a planet-type ball mill. The mixing was carried out under the ball mill condition of a rotation rate of 400 rpm, for a rotation time of 1 hour using zirconia balls of 1 mm diameter and a zirconia pot as a mill pot.

The obtained powder was mixed with a solution obtained by dissolving 15% by weight of sucrose with respect to the obtained powder in an aqueous solution, and the mixture was well mixed using an agate mortar and dried at 60° C. The obtained powder was placed into a quartz pot and was fired in a nitrogen atmosphere at a firing temperature of 550° C. for a firing time of 12 hours at a temperature rising and lowering rate of 200° C./h to obtain LiMn_{0.9375}Zr_{0.0625}P_{0.875}Si_{0.125}O₄. It was confirmed that 2.2 parts by weight of carbon with respect to 100 parts by weight of a sample was attached to the surface of LiMn_{0.9375}Zr_{0.0625}P_{0.94}Si_{0.06}O₄. LiMn_{0.9375}Zr_{0.0625}P_{0.94}Si_{0.06}O₄ was mixed with ZrO₂ at a molar ratio of 1:0.03 to obtain a sample composed of LiMn_{0.9375}Zr_{0.0625}P_{0.94}Si_{0.06}O₄ and 0.03ZrO₂.

The powder X-ray diffraction pattern of the obtained sample was measured using a powder X-ray diffraction apparatus MiniFlex II (manufactured by Rigaku Co., Ltd.). When a ratio (A/B) between the peak intensity (A) derived from a metal oxide near 30.4 degrees and the peak intensity (B) derived from phosphate near 25.5 degrees was calculated from the obtained result, the ratio was about 0.16.

Thereafter, a flat-plate laminate battery was prepared by carrying out the same operation as in Comparative Example 1.

### Example 6

### Preparation of Cathode Active Material

As starting source materials, there were used LiCH₃COO as a lithium source, MnCO₃.0.5H₂O as a manganese source, AlCl₃.6H₂O as an aluminum source, (NH₄)₂HPO₄ as a phosphorus source, and SiO₂ as a silicon source. By setting the weight of LiCH₃COO serving as the lithium source to be 0.6599 g, each of the above materials was weighed so that the molar ratio of Li:Mn:Al:P:Si was set to 1:0.85:0.15:0.85:0.15. The materials were well mixed using an agate mortar. The obtained mixture was ground and mixed using a planet-type ball mill. The mixing was carried out under the ball mill condition of a rotation rate of 400 rpm, for a rotation time of 1 hour using zirconia balls of 1 mm diameter and a zirconia pot as a mill pot.

The obtained powder was mixed with a solution obtained by dissolving 15% by weight of sucrose with respect to the obtained powder in an aqueous solution, and the mixture was well mixed using an agate mortar and dried at 60° C. The obtained powder was placed into a quartz pot and was fired in a nitrogen atmosphere at a firing temperature of 550° C. for a firing time of 12 hours at a temperature rising and lowering rate of 200° C./h to obtain LiMn_{0.85}Al_{0.15}P_{0.85}Si_{0.15}O₄. It was confirmed that 2.2 parts by weight of carbon with respect to 100 parts by weight of a sample was attached to the surface of LiMn_{0.85}Al_{0.15}P_{0.85}Si_{0.15}O₄. LiMn_{0.85}Al_{0.15}P_{0.85}Si_{0.15}O₄ was mixed with ZrO₂ at a molar ratio of 1:0.03 to obtain a sample composed of LiMn_{0.85}Al_{0.15}P_{0.85}Si_{0.15}O₄ and 0.03ZrO₂.

The powder X-ray diffraction pattern of the obtained sample was measured using a powder X-ray diffraction apparatus MiniFlex II (manufactured by Rigaku Co., Ltd.). When a ratio (A/B) between the peak intensity (A) derived from a metal oxide near 30.4 degrees and the peak intensity (B) derived from phosphate near 25.5 degrees was calculated from the obtained result, the ratio was about 0.15.

Thereafter, a flat-plate laminate battery was prepared by carrying out the same operation as in Comparative Example 1.

### Example 7

### Preparation of Cathode Active Material

A powder having a composition ratio of each element shown in Table 1 was synthesized by the same procedure as in Example except that by setting the weight of LiCH₃COO serving as a lithium source to be 0.6599 g, each of the above materials was weighed so that the molar ratio of Li:Mn:Zr:P:Si was set as shown in Table 1.

Thereafter, a flat-plate laminate battery was prepared by carrying out the same operation as in Example 1 using the obtained powder.

### Example 8

### Preparation of Cathode Active Material

A powder having a composition ratio of each element shown in Table 1 was synthesized by the same procedure as in Example except that by setting the weight of LiCH₃COO serving as a lithium source to be 0.6599 g, each of the above materials was weighed so that the molar ratio of Li:Mn:Zr:P:Si was set as shown in Table 1.

Thereafter, a flat-plate laminate battery was prepared by carrying out the same operation as in Example 1 using the obtained powder.

### Example 9

### Preparation of Cathode Active Material

A powder having a composition ratio of each element shown in Table 1 was synthesized by the same procedure as in Example except that by setting the weight of LiCH₃COO serving as a lithium source to be 0.6599 g, each of the above materials was weighed so that the molar ratio of Li:Mn:Zr:P:Si was set as shown in Table 1.

Thereafter, a flat-plate laminate battery was prepared by carrying out the same operation as in Example 1 using the obtained powder.

### Example 10

### Preparation of Cathode Active Material

A powder having a composition ratio of each element shown in Table 1 was synthesized by the same procedure as in Example except that by setting the weight of LiCH₃COO serving as a lithium source to be 0.6599 g, each of the above materials was weighed so that the molar ratio of Li:Mn:Zr:P:Si was set as shown in Table 1.

Thereafter, a flat-plate laminate battery was prepared by carrying out the same operation as in Example 1 using the obtained powder.

### Example 11

### Preparation of Cathode Active Material

A powder having a composition ratio of each element shown in Table 1 was synthesized by the same procedure as in Example except that by setting the weight of LiCH₃COO serving as a lithium source to be 0.6599 g, each of the above materials was weighed so that the molar ratio of Li:Mn:Zr:P:Si was set as shown in Table 1.

Thereafter, a flat-plate laminate battery was prepared by carrying out the same operation as in Example 1 using the obtained powder.

### Example 12

### Preparation of Cathode Active Material

A powder having a composition ratio of each element shown in Table 1 was synthesized by the same procedure as in Example except that by setting the weight of LiCH₃COO serving as a lithium source to be 0.6599 g, each of the above materials was weighed so that the molar ratio of Li:Mn:Zr:P:Si was set as shown in Table 1.

Thereafter, a flat-plate laminate battery was prepared by carrying out the same operation as in Example 1 using the obtained powder.

### Example 13

### Preparation of Cathode Active Material

A powder having a composition ratio of each element shown in Table 1 was synthesized by the same procedure as in Example except that by setting the weight of LiCH₃COO serving as a lithium source to be 0.6599 g, each of the above materials was weighed so that the molar ratio of Li:Mn:Zr:P:Si was set as shown in Table 1.

Thereafter, a flat-plate laminate battery was prepared by carrying out the same operation as in Example 1 using the obtained powder.

### Example 14

### Preparation of Cathode Active Material

A powder having a composition ratio of each element shown in Table 1 was synthesized by the same procedure as in Example except that by setting the weight of LiCH₃COO serving as a lithium source to be 0.6599 g, each of the above materials was weighed so that the molar ratio of Li:Mn:Zr:P:Si was set as shown in Table 1.

Thereafter, a flat-plate laminate battery was prepared by carrying out the same operation as in Example 1 using the obtained powder.

### Example 15

### Preparation of Cathode Active Material

A powder having a composition ratio of each element shown in Table 1 was synthesized by the same procedure as in Example except that by setting the weight of LiCH₃COO serving as a lithium source to be 0.6599 g, each of the above materials was weighed so that the molar ratio of Li:Mn:Zr:P:Si was set as shown in Table 1.

Thereafter, a flat-plate laminate battery was prepared by carrying out the same operation as in Example 1 using the obtained powder.

### Example 16

### Preparation of Cathode Active Material

A powder having a composition ratio of each element shown in Table 1 was synthesized by the same procedure as in Example except that by setting the weight of LiCH₃COO serving as a lithium source to be 0.6599 g, each of the above materials was weighed so that the molar ratio of Li:Mn:Zr:P:Si was set as shown in Table 1.

Thereafter, a flat-plate laminate battery was prepared by carrying out the same operation as in Example 1 using the obtained powder.

### Example 17

### Preparation of Cathode Active Material

A powder having a composition ratio of each element shown in Table 1 was synthesized by the same procedure as in Example except that by setting the weight of LiCH₃COO serving as a lithium source to be 0.6599 g, each of the above materials was weighed so that the molar ratio of Li:Mn:Zr:P:Si was set as shown in Table 1.

Thereafter, a flat-plate laminate battery was prepared by carrying out the same operation as in Example 1 using the obtained powder.

### Example 18

### Preparation of Cathode Active Material

A powder having a composition ratio of each element shown in Table 2 was synthesized by the same procedure as in Example except that by setting the weight of LiCH₃COO serving as a lithium source to be 0.6599 g, each of the above materials was weighed so that the molar ratio of Li:Mn:Zr:P:Si was set as shown in Table 2.

Thereafter, a flat-plate laminate battery was prepared by carrying out the same operation as in Example 1 using the obtained powder.

### Example 19

### Preparation of Cathode Active Material

A powder having a composition ratio of each element shown in Table 2 was synthesized by the same procedure as in Example except that by setting the weight of LiCH₃COO serving as a lithium source to be 0.6599 g, each of the above materials was weighed so that the molar ratio of Li:Mn:Zr:P:Si was set as shown in Table 2.

Thereafter, a flat-plate laminate battery was prepared by carrying out the same operation as in Example 1 using the obtained powder.

### Example 20

### Preparation of Cathode Active Material

A powder having a composition ratio of each element shown in Table 2 was synthesized by the same procedure as in Example except that by setting the weight of LiCH₃COO serving as a lithium source to be 0.6599 g, each of the above materials was weighed so that the molar ratio of Li:Mn:Zr:P:Si was set as shown in Table 2.

Thereafter, a flat-plate laminate battery was prepared by carrying out the same operation as in Example 1 using the obtained powder.

### Example 21

### Preparation of Cathode Active Material

A powder having a composition ratio of each element shown in Table 2 was synthesized by the same procedure as in Example except that by setting the weight of LiCH₃COO serving as a lithium source to be 0.6599 g, each of the above materials was weighed so that the molar ratio of Li:Mn:Zr:P:Al was set as shown in Table 2.

Thereafter, a flat-plate laminate battery was prepared by carrying out the same operation as in Example 1 using the obtained powder.

### Example 22

### Preparation of Cathode Active Material

A powder having a composition ratio of each element shown in Table 2 was synthesized by the same procedure as in Example except that by setting the weight of LiCH₃COO serving as a lithium source to be 0.6599 g, each of the above materials was weighed so that the molar ratio of Li:Mn:Zr:P:Al was set as shown in Table 2.

Thereafter, a flat-plate laminate battery was prepared by carrying out the same operation as in Example 1 using the obtained powder.

### Example 23

### Preparation of Cathode Active Material

A powder having a composition ratio of each element shown in Table 2 was synthesized by the same procedure as in Example except that by setting the weight of LiCH₃COO serving as a lithium source to be 0.6599 g, each of the above materials was weighed so that the molar ratio of Li:Mn:Zr:Sn:Al:P:Si was set as shown in Table 2.

Thereafter, a flat-plate laminate battery was prepared by carrying out the same operation as in Example 1 using the obtained powder.

### Example 24

### Preparation of Cathode Active Material

A powder having a composition ratio of each element shown in Table 2 was synthesized by the same procedure as in Example except that by setting the weight of LiCH₃COO serving as a lithium source to be 0.6599 g, each of the above materials was weighed so that the molar ratio of Li:Mn:Zr:Sn:Al:P:Si was set as shown in Table 2.

Thereafter, a flat-plate laminate battery was prepared by carrying out the same operation as in Example 1 using the obtained powder.

### Example 25

### Preparation of Cathode Active Material

A powder having a composition ratio of each element shown in Table 2 was synthesized by the same procedure as in Example except that by setting the weight of LiCH₃COO serving as a lithium source to be 0.6599 g, each of the above materials was weighed so that the molar ratio of Li:Mn:Sn:P:Si was set as shown in Table 2.

Thereafter, a flat-plate laminate battery was prepared by carrying out the same operation as in Example 1 using the obtained powder.

### Example 26

### Preparation of Cathode Active Material

A powder having a composition ratio of each element shown in Table 2 was synthesized by the same procedure as in Example except that by setting the weight of LiCH₃COO serving as a lithium source to be 0.6599 g, each of the above materials was weighed so that the molar ratio of Li:Mn:Sn:P:Si was set as shown in Table 2.

Thereafter, a flat-plate laminate battery was prepared by carrying out the same operation as in Example 1 using the obtained powder.

### Example 27

### Preparation of Cathode Active Material

A powder having a composition ratio of each element shown in Table 2 was synthesized by the same procedure as in Example except that by setting the weight of LiCH₃COO serving as a lithium source to be 0.6599 g, each of the above materials was weighed so that the molar ratio of Li:Mn:Al:P:Si was set as shown in Table 2.

Thereafter, a flat-plate laminate battery was prepared by carrying out the same operation as in Example 1 using the obtained powder.

### Example 28

### Preparation of Cathode Active Material

A powder having a composition ratio of each element shown in Table 2 was synthesized by the same procedure as in Example except that by setting the weight of LiCH₃COO serving as a lithium source to be 0.6599 g, each of the above materials was weighed so that the molar ratio of Li:Mn:Al:P:Si was set as shown in Table 2.

Thereafter, a flat-plate laminate battery was prepared by carrying out the same operation as in Example 1 using the obtained powder.

### Example 29

### Preparation of Cathode Active Material

A powder having a composition ratio of each element shown in Table 2 was synthesized by the same procedure as in Example except that by setting the weight of LiCH₃COO serving as a lithium source to be 0.6599 g, each of the above materials was weighed so that the molar ratio of Li:Mn:Al:P:Si was set as shown in Table 2.

Thereafter, a flat-plate laminate battery was prepared by carrying out the same operation as in Example 1 using the obtained powder.

### Example 30

### Preparation of Cathode Active Material

A powder having a composition ratio of each element shown in Table 2 was synthesized by the same procedure as in Example except that by setting the weight of LiCH₃COO serving as a lithium source to be 0.6599 g, each of the above materials was weighed so that the molar ratio of Li:Mn:Zr:Sn:P:Si was set as shown in Table 2.

Thereafter, a flat-plate laminate battery was prepared by carrying out the same operation as in Example 1 using the obtained powder.

### Example 31

### Preparation of Cathode Active Material

A powder having a composition ratio of each element shown in Table 2 was synthesized by the same procedure as in

Example except that by setting the weight of LiCH₃COO serving as a lithium source to be 0.6599 g, each of the above materials was weighed so that the molar ratio of Li:Mn:Zr:Sn:P:Si was set as shown in Table 2.

Thereafter, a flat-plate laminate battery was prepared by carrying out the same operation as in Example 1 using the obtained powder.

### Example 32

### Preparation of Cathode Active Material

A powder having a composition ratio of each element shown in Table 2 was synthesized by the same procedure as in Example except that by setting the weight of LiCH₃COO serving as a lithium source to be 0.6599 g, each of the above materials was weighed so that the molar ratio of Li:Mn:Zr:Sn:P:Si was set as shown in Table 2.

Thereafter, a flat-plate laminate battery was prepared by carrying out the same operation as in Example 1 using the obtained powder.

### Example 33

### Preparation of Cathode Active Material

A powder having a composition ratio of each element shown in Table 2 was synthesized by the same procedure as in Example except that by setting the weight of LiCH₃COO serving as a lithium source to be 0.6599 g, each of the above materials was weighed so that the molar ratio of Li:Mn:Zr:Al:P:Si was set as shown in Table 2.

Thereafter, a flat-plate laminate battery was prepared by carrying out the same operation as in Example 1 using the obtained powder.

### Example 34

### Preparation of Cathode Active Material

A powder having a composition ratio of each element shown in Table 2 was synthesized by the same procedure as in Example except that by setting the weight of LiCH₃COO serving as a lithium source to be 0.6599 g, each of the above materials was weighed so that the molar ratio of Li:Mn:Zr:Al:P:Si was set as shown in Table 2.

Thereafter, a flat-plate laminate battery was prepared by carrying out the same operation as in Example 1 using the obtained powder.

### Example 35

### Preparation of Cathode Active Material

A powder having a composition ratio of each element shown in Table 2 was synthesized by the same procedure as in Example except that by setting the weight of LiCH₃COO serving as a lithium source to be 0.6599 g, each of the above materials was weighed so that the molar ratio of Li:Mn:Sn:Al:P:Si was set as shown in Table 2.

Thereafter, a flat-plate laminate battery was prepared by carrying out the same operation as in Example 1 using the obtained powder.

### (Evaluation of Battery)

### (1) Utilization Ratio and Rate Characteristics

The battery was charged in an environment of 25° C. The charging rate was set to 0.1 C and when the potential of the battery reached 4.5 V, the charging was ended to obtain a charge capacity. After the charging was ended, the battery was discharged at a discharge rate of 0.1 C and when the potential of the battery reached 2.25 V, the discharging was ended to obtain a discharge capacity.

The first charging and discharging was followed by Charging and discharging at a discharging rate 1 C (the charging rate was the same as 0.1 C).

The utilization ratio and the rate characteristics were calculated from the obtained result by the following formulae.

Utilization ratio(%)=discharge capacity/theoretical capacity×100

Rate characteristics(%)=discharge capacity at 1 C/discharge capacity at 0.1 C×100

### (2) Average Discharge Potential

The average discharge potential was an average value of values obtained by detecting a voltage shown at a constant current when the battery was discharged at regular intervals.

### (3) Cycle Characteristics

The battery was initially charged in an environment of 25° C. The charging rate was set to 0.1 C and when the potential of the battery reached 4.5 V, the charging was ended. After the charging was ended, the battery was discharged at a discharge rate of 0.1 C and when the potential of the battery reached 2.25 V, the discharging was ended to determine an initial discharge capacity of the battery. Further, charging and discharging were repeated in the same manner as in the initial charging and discharging, the discharge capacity in the 500th run was measured, and the cycle characteristics were obtained by the following formula.

Cycle characteristics=discharge capacity in 500th run/initial discharge capacity×100

The physical properties of the cathode active materials in Examples and Comparative Examples are shown in Tables 1 and 2 and the above evaluations are shown in Tables 3 and 4.

TABLE 1

| | | First phase | | | | | | | | | | |
|---|---|---|---|---|---|---|---|---|---|---|---|---|
| | | | | M | | | | X | | | | |
| | | Li | Mn | Zr | Sn | Al | P | Si | Al | Second phase | Peak intensity ratio | |
| | | a | c | d | | | e | f | | M′bOz | of second phase | Addition form |
| Comparative | 1 | 1.01 | 1 | — | — | — | 1 | — | — | — | — | — |
| Example | 2 | 1.01 | 0.97 | 0.03 | — | — | 0.94 | 0.06 | — | — | — | — |
| Example | 1 | 1.03 | 1.01 | — | — | — | 1 | — | — | 0.03Zr02 | 0.12 | Simultaneously fired |
| | 2 | 1.02 | 0.98 | 0.03 | — | — | 0.94 | 0.06 | — | 0.03Zr02 | 0.11 | Simultaneously fired |
| | 3 | 1.03 | 0.9375 | 0.0625 | — | — | 0.885 | 0.125 | — | 0.03Zr02 | 0.1 | Simultaneously fired |
| | 4 | 1.04 | 0.74 | 0.125 | — | 0.125 | 0.625 | 0.375 | — | 0.03Zr02 | 0.1 | Simultaneously fired |
| | 5 | 1.08 | 0.9375 | 0.0625 | — | — | 0.875 | 0.125 | — | 0.03Zr02 | 0.16 | Mixed after being fired |
| | 6 | 0.98 | 0.85 | — | — | 0.15 | 0.85 | 0.15 | — | 0.03Zr02 | 0.15 | Mixed after being fired |
| | 7 | 0.97 | 0.9825 | 0.0175 | — | — | 0.965 | 0.035 | — | 0.03Zr02 | 0.08 | Simultaneously fired |
| | 8 | 0.99 | 0.975 | 0.025 | — | — | 0.965 | 0.025 | — | 0.03Zr02 | 0.12 | Simultaneously fired |
| | 9 | 1.02 | 0.975 | 0.025 | — | — | 0.95 | 0.05 | — | 0.03Zr02 | 0.08 | Simultaneously fired |
| | 10 | 1.02 | 0.965 | 0.035 | — | — | 0.95 | 0.04 | — | 0.03Zr02 | 0.09 | Simultaneously fired |
| | 11 | 0.96 | 0.97 | 0.05 | — | — | 0.95 | 0.06 | — | 0.03Zr02 | 0.11 | Simultaneously fired |
| | 12 | 0.94 | 0.95 | 0.06 | — | — | 0.955 | 0.05 | — | 0.06Zr02 | 0.18 | Simultaneously fired |
| | 13 | 1.08 | 0.95 | 0.05 | — | — | 0.95 | 0.05 | — | 0.15Zr02 | 0.27 | Simultaneously fired |
| | 14 | 1.02 | 0.95 | 0.05 | — | — | 0.95 | 0.05 | — | 0.015Zr02, | 0.05, 0.04 | Simultaneously fired |
| | | | | | | | | | | 0.015Sn02 | | |
| | 15 | 1.02 | 0.95 | 0.05 | — | — | 0.95 | 0.05 | — | 0.015Zr02, | 0.06, 0.04 | Simultaneously fired |
| | | | | | | | | | | 0.015Al203 | | |
| | 16 | 1.02 | 0.95 | 0.05 | — | — | 0.95 | 0.05 | — | 0.015Zr02, | 0.05, 0.02 | Simultaneously fired |
| | | | | | | | | | | 0.015Si02 | | |
| | 17 | 1.03 | 0.95 | 0.05 | — | — | 0.95 | 0.05 | — | 0.03Sn02 | 0.07 | Simultaneously fired |

TABLE 2

| | | First phase | | | | | | | | | | |
|---|---|---|---|---|---|---|---|---|---|---|---|---|
| | | | | M | | | | X | | Second | Peak intensity | |
| | | Li | Mn | Zr | Sn | Al | P | Si | Al | phase | ratio of second | |
| | | a | c | d | | | e | f | | M′bOz | phase | Addition form |
| Example | 18 | 1.01 | 0.95 | 0.05 | — | — | 0.95 | 0.05 | — | 0.03Al203 | 0.08 | Simultaneously fired |
| | 19 | 1.01 | 0.95 | 0.05 | — | — | 0.95 | 0.05 | — | 0.03Si02 | 0.03 | Simultaneously fired |
| | 20 | 1.05 | 0.95 | 0.05 | — | — | 0.9 | 0.1 | — | 0.03Zr02 | 0.07 | Simultaneously fired |
| | 21 | 1.01 | 0.975 | 0.025 | — | — | 0.975 | — | 0.025 | 0.03Zr02 | 0.08 | Simultaneously fired |
| | 22 | 1.02 | 0.95 | 0.05 | — | — | 0.95 | — | 0.05 | 0.03Zr02 | 0.08 | Simultaneously fired |
| | 23 | 1.03 | 0.975 | 0.0083 | 0.0083 | 0.0083 | 0.9583 | 0.0417 | — | 0.03Zr02 | 0.07 | Simultaneously fired |
| | 24 | 1.03 | 0.95 | 0.0167 | 0.0167 | 0.0167 | 0.9167 | 0.083 | — | 0.03Zr02 | 0.08 | Simultaneously fired |
| | 25 | 1.03 | 0.9825 | — | 0.175 | — | 0.965 | 0.035 | — | 0.03Sn02 | 0.07 | Simultaneously fired |
| | 26 | 1.03 | 0.95 | — | 0.05 | — | 0.95 | 0.05 | — | 0.03Sn02 | 0.11 | Simultaneously fired |
| | 27 | 1.04 | 0.9825 | — | — | 0.0175 | 0.9825 | 0.0175 | — | 0.03Al203 | 0.06 | Simultaneously fired |
| | 28 | 1.05 | 0.975 | — | — | 0.025 | 0.975 | 0.025 | — | 0.03Al203 | 0.06 | Simultaneously fired |
| | 29 | 1.01 | 0.95 | — | — | 0.05 | 0.95 | 0.05 | — | 0.03Al203 | 0.05 | Simultaneously fired |
| | 30 | 1.00 | 0.95 | 0.025 | 0.025 | — | 0.95 | 0.05 | — | 0.03Zr02 | 0.12 | Simultaneously fired |
| | 31 | 1.06 | 0.95 | 0.025 | 0.025 | — | 0.9 | 0.1 | — | 0.03Zr02 | 0.08 | Simultaneously fired |
| | 32 | 1.02 | 0.95 | 0.025 | 0.025 | — | 0.9 | 0.1 | — | 0.03Sn02 | 0.07 | Simultaneously fired |
| | 33 | 1.03 | 0.95 | 0.025 | — | 0.025 | 0.925 | 0.075 | — | 0.03Zr02 | 0.07 | Simultaneously fired |
| | 34 | 1.02 | 0.95 | 0.025 | — | 0.025 | 0.925 | 0.075 | — | 0.03Al203 | 0.06 | Simultaneously fired |
| | 35 | 1.04 | 0.95 | — | 0.025 | 0.025 | 0.925 | 0.075 | — | 0.03Sn02 | 0.07 | Simultaneously fired |

TABLE 3

| | | | | | Average |
|---|---|---|---|---|---|
| | | Utilization | Rate | Cycle | discharge |
| | | ratio | characteristics | characteristics | potential |
| | | (%) | (%) | (%) | (mV) |
| Com- | 1 | 34.8 | 50.4 | 43.0 | 3202.6 |
| parative | 2 | 40.2 | 60.6 | 60.1 | 3348.5 |
| Example | | | | | |
| Example | 1 | 40.7 | 56.1 | 64.5 | 3251.9 |
| | 2 | 54.1 | 76.4 | 75.0 | 3632.0 |
| | 3 | 54.3 | 84.3 | 80.5 | 3625.3 |
| | 4 | 55.8 | 86.2 | 77.0 | 3648.3 |
| | 5 | 47.8 | 77.2 | 63.7 | 3387.5 |
| | 6 | 49.2 | 80.1 | 62.9 | 3406.3 |
| | 7 | 50.2 | 71.2 | 69.5 | 3396.5 |
| | 8 | 51.9 | 71.9 | 69.6 | 3397.2 |
| | 9 | 52.1 | 74.9 | 72.5 | 3405.2 |
| | 10 | 52.3 | 72 | 69.9 | 3369.5 |
| | 11 | 53.6 | 75.2 | 70.4 | 3408.2 |
| | 12 | 52.2 | 85.2 | 76.5 | 3427.5 |
| | 13 | 52.2 | 78.5 | 83.2 | 3412.3 |
| | 14 | 51.6 | 74.9 | 76.9 | 3405.1 |
| | 15 | 51.8 | 71.7 | 73.5 | 3396.9 |
| | 16 | 52.0 | 75 | 77.6 | 3404.8 |
| | 17 | 51.5 | 73.2 | 71.5 | 3405.9 |

TABLE 4

| | | | | | Average |
|---|---|---|---|---|---|
| | | Utilization | Rate | Cycle | discharge |
| | | ratio | characteristics | characteristics | potential |
| | | (%) | (%) | (%) | (mV) |
| Example | 18 | 51.7 | 71.5 | 69.5 | 3396.4 |
| | 19 | 51.0 | 74.9 | 71.8 | 3406.9 |
| | 20 | 54.1 | 78.5 | 77.5 | 3411.0 |
| | 21 | 52.1 | 72.5 | 71.4 | 3398.4 |
| | 22 | 53.5 | 72.3 | 70.6 | 3374.5 |
| | 23 | 50.8 | 71.8 | 69.2 | 3395.8 |
| | 24 | 51.8 | 72.6 | 70.9 | 3403.5 |
| | 25 | 49.5 | 70.2 | 68.5 | 3393.5 |
| | 26 | 50.5 | 70.9 | 68.5 | 3394.6 |
| | 27 | 48.8 | 69.5 | 64.2 | 3393.8 |
| | 28 | 50.2 | 69.5 | 68.2 | 3394.2 |
| | 29 | 50.8 | 70.3 | 69.9 | 3394.5 |
| | 30 | 53.1 | 74.8 | 71.5 | 3403.5 |
| | 31 | 52.4 | 74.2 | 72.3 | 3401.2 |
| | 32 | 52.4 | 73.5 | 71.5 | 3400.4 |
| | 33 | 55.6 | 86.2 | 77.2 | 3415.2 |
| | 34 | 50.2 | 73.9 | 70.5 | 3399.2 |
| | 35 | 51 | 70.5 | 70.1 | 3396.2 |

From Tables 3 and 4, it is found that the batteries in Examples 1 to 35 were excellent in all evaluations compared to the batteries in Comparative Examples 1 and 2. For example, while the rate characteristics in Example 2 are 76.4%, the rate characteristics in Comparative Example 1 are 50.4%. The value in Example 2 is remarkably high.

In addition, while the utilization ratio in Example 2 is 54.1%, the utilization ratio in Comparative Example 1 is 34.8%. The utilization ratio is remarkably increased.

Further, while the average discharge potential in Example 2 is 3632.0 mV, the average discharge potential in Comparative Example 1 is 3202.6 mV. The value of the average discharge potential in Example 2 is remarkably high and thus the average discharge potential in Example 2 is remarkably increased even in comparison of the energy density.

The cycle characteristics in Example 2 and Comparative Example 1 were 75% and 43%, respectively. From the result, it is found that the cathode active material including a metal oxide can suppress a capacity decrease due to the battery cycles.

For the tendency of the substitution element of the M site, it is found that good rate characteristics are exhibited in the order of Zr—Al>Zr>Zr—Sn>Zr—Sn—Al>Sn>Sn—Al>Al. In addition, there is a tendency that good rate characteristics are exhibited in the order of Si>Al in the X site. For the metal oxide, ZrO₂ and SiO₂ exhibit equal rate characteristics, and good rate characteristics are exhibited in the order of SnO₂>Al₂O₂.

1. A cathode active material for a non-aqueous electrolyte secondary battery comprising:
phosphate containing lithium and manganese, in which a manganese site is substituted with at least one element selected from Zr, Sn, Y, and Al, and a phosphorous site is substituted with at least one element selected from Si and Al; and
a metal oxide.

2. The cathode active material for a non-aqueous electrolyte secondary battery according to claim 1,
wherein the phosphate has a composition represented by the following formula (1)
LiₐMn_{c}M_{d}PₑX_{f}O_{g} (1)
(wherein M is at least one element selected from Zr, Sn, Y and Al; X is at least one element selected from Al and Si; 0≦a≦1.1; 0<c≦1.1; 0<d≦0.5; 0<e≦1.1; 0<f≦0.5; and g is a value determined to satisfy an electroneutral condition), and
the metal oxide has a composition represented by the following formula (2)
M′_{b}O_{z} (2)
(wherein in the formula, M′ is at least one element selected from Zr, Sn, Y, Al, and Si; and (valence of M′)×b=4z).

3. The cathode active material for a non-aqueous electrolyte secondary battery according to claim 2,
wherein 0<d≦0.25 and 0<f≦0.375.

4. The cathode active material for a non-aqueous electrolyte secondary battery according to claim 3,
wherein the M′ is at least one element selected from Zr and Si.

5. The cathode active material for a non-aqueous electrolyte secondary battery according to claim 4,
wherein the M has a mixed composition of Zr and Al and the M′ is Zr.
